(19) United States
(12) Patent Application Publication
(10) Pub. No.: US 2010/0177075 A1
(43) Pub. Date: Jul. 15, 2010

(54) ELECTROLUMINESCENT DISPLAY DEVICES

(75) Inventors: David A. Fish, Haywards Heath (GB); Nigel D. Young, Redhill (GB); Mark J. Childs, Swindon (GB)

Correspondence Address: PHILIPS INTELLECTUAL PROPERTY & STANDARDS, PO BOX 3001, BRIARCLIFF MANOR, NY, 10510-8001, US

(73) Assignee: KONINKLIJKE PHILIPS ELECTRONICS N.V., Eindhoven (NL)

(21) Appl. No.: 11/993,640

(22) PCT Filed: Jun. 15, 2006
(86) PCT No.: PCT/IB06/51924

§ 371 Date: Dec. 21, 2007

(30) Foreign Application Priority Data
Jun. 30, 2005 (EP) 05105971.5

(51) Int. Cl. G09G 5/10

(52) U.S. Cl. 345/207

(57) ABSTRACT

An active matrix LED display device uses optical feedback for controlling the pixel drive transistors (2). The LED display elements are controlled to provide a pulsed output, and the optical feedback element (66,68) is controlled cyclically such that, for constant illumination of the optical feedback element (66,68) during a cycle, there is a substantially zero net output charge flow. This arrangement uses pulsed light output, and arranges the optical feedback to operate only in response to a corresponding pulsed light input. In this way, ambient light, which will be uniform over the time period of the cycle of operation, will not influence the optical feedback system. In this way, the system is not influenced by ambient light conditions.

This invention relates to electroluminescent display devices, particularly active matrix display devices having an array of pixels comprising light-emitting electroluminescent display elements and thin film transistors. More particularly, but not exclusively, the invention is concerned with an active matrix electroluminescent display device whose pixels include light sensing to elements which are responsive to light emitted by the display elements and used in the control of energisation of the display elements.

Matrix display devices employing electroluminescent, light-emitting, display elements are well known. The display elements commonly comprise organic thin film electroluminescent elements, (OLEDs), including polymer materials (PLEDs), or else light emitting diodes (LEDs). The term LED used below is intended to cover all of these possibilities. These materials typically comprise one or more layers of a semiconducting conjugated polymer sandwiched between a pair of electrodes, one of which is transparent and the other of which is of a material suitable for injecting holes or electrons into the polymer layer.

The display elements in such display devices are current driven and a conventional, analogue, drive scheme involves supplying a controllable current to the display element. Typically a current source transistor is provided as part of the pixel configuration, with the gate voltage supplied to the current source transistor determining the current through the electroluminescent (EL) display element. A storage capacitor holds the gate voltage after the addressing phase. An example of such a pixel circuit is described in EP-A-0717446.

Each pixel thus comprises the EL display element and associated driver circuitry. The driver circuitry has an address transistor which is turned on by a row address pulse on a row conductor. When the address transistor is turned on, a data voltage on a column conductor can pass to the remainder of the pixel. In particular, the address transistor supplies the column conductor voltage to the current source, comprising the drive transistor and the storage capacitor connected to the gate of the drive transistor. The column, data, voltage is provided to the gate of the drive transistor and the gate is held at this voltage by the storage capacitor even after the row address pulse has ended. The drive transistor in this circuit is implemented as a p-channel TFT, (Thin Film Transistor) so that the storage capacitor holds the gate-source voltage fixed. This results in a fixed source-drain current through the transistor, which therefore provides the desired current source operation of the pixel. The brightness of the EL display element is approximately proportional to the current flowing through it.

In the above basic pixel circuit, differential ageing, or degradation, of the LED material, leading to a reduction in the brightness level of a pixel for a given drive current, can give rise to variations in image quality across a display. A display element that has been used extensively will be much dimmer than a display element that has been used rarely. Also, display non-uniformity problems can arise due to the variability in the characteristics of the drive transistors, particularly the threshold voltage level.

Improved voltage-addressed pixel circuits which can compensate for the ageing of the LED material and variation in transistor characteristics have been proposed. These include a light sensing element which is responsive to the light output of the display element and acts to leak stored charge on the storage capacitor in response to the light output so as to control the integrated light output of the display element during the drive period which follows the initial addressing of the pixel. Examples of this type of pixel configuration are described in detail in WO 01/20591 and EP 1 096 466. In an example embodiment, a photodiode in the pixel discharges the gate voltage stored on the storage capacitor and the EL display element ceases to emit when the gate voltage on the drive transistor reaches the threshold voltage, at which time the storage capacitor stops discharging. The rate at which charge is leaked from the photodiode is a function of the display element output, so that the photodiode serves as a light-sensitive feedback device.

With this arrangement, the light output from a display element is independent of the EL display element efficiency and ageing compensation is thereby provided. Such a technique has been shown to be effective in achieving a high quality display which suffers less from non-uniformities over a period of time. However, this method requires a high instantaneous peak brightness level to achieve adequate average brightness from a pixel in a frame time and this is not beneficial to the operation of the display as the LED material is likely to age more rapidly as a result.

In an alternative approach, the optical feedback system is used to to change the duty cycle with which the display element is operated. The display element is driven to a fixed brightness, and the optical feedback is used to trigger a transistor switch which turns off the drive transistor rapidly. This avoids the need for high instantaneous brightness levels, but introduces additional complexity to the pixel.

The use of optical feedback systems is considered as an effective way of overcoming differential ageing of the LED display elements.

One problem with these compensation schemes is that the light sensitive element is sensitive to ambient light, so that ambient light levels can influence the optical feedback scheme. It has been proposed to overcome this problem by using light blocking layers as part of the pixel design, so that there is shielding from ambient light. This introduces additional complexity into the pixel design and manufacture.

Another problem relates to cross talk between adjacent pixels. A path of light must be provided between the LED display element and the light sensitive device for operation of the feedback scheme. Any stray light which is not absorbed by the light sensitive device can be captured by the light sensitive device of a different pixel.

According to the invention, there is provided an active matrix display device comprising an array of display pixels, each pixel comprising:

a current-driven light emitting display element;

a light-dependent device arrangement for detecting the brightness of the display element and providing an output charge flow in dependence on the brightness of the display element; and

a drive transistor for driving a current through the display element, wherein the drive transistor is controlled in response to the light-dependent device arrangement output, wherein

the current-driven light emitting display element is controlled to provide a pulsed output, and

the light-dependent device arrangement is controlled cyclically such to that, for constant illumination of the light-dependent device arrangement during a cycle, there is a substantially zero net output charge flow.

This arrangement uses pulsed light output, and arranges the optical feedback to operate only in response to a corresponding pulsed light input. In this way, ambient light, which will be uniform over the time period of the cycle of operation, will not influence the optical feedback system. In this way, the system is not influenced by ambient light conditions.

The light dependent device arrangement can be controlled by a control signal having the same timing as a pulse timing control signal for the display element. This links the dependence of the optical feedback on the characteristics of the display element output. A shared control signal can provide the pulse timing control and cyclic control.

The light-dependent device arrangement can comprise first and second photodiodes in series between power lines, with the output from the arrangement at the junction between the photodiodes, and wherein the cyclic control actuates the photodiodes alternately. The photodiodes provide charge flow in opposite directions, so that the charge flows resulting from constant illumination cancel. Transistors can be used for providing the actuation of the photodiodes.

The light-dependent device arrangement can instead comprise a phototransistor, which is controlled to provide photocurrent in opposite directions in dependence on the operation cycle.

The drive transistor, the display element and a pulsing transistor can be provided in series between power lines, the pulsing transistor being switched by a pulse timing control signal. This provides the pulsed control of the display element output in a simple manner.

The array of display pixels can be arranged as first and second sets of display pixels, and the pulsed output of the display pixels of one set can be out of phase with the pulsed output of the display pixels of the other set. This enables optical cross talk between adjacent pixels to be reduced, which can also affect the optical feedback operation. For example, the pulsed output of to each pixel can be out of phase with the pulse output of the pixel on each side and/or above and below in the array. The pulsed output of the display pixels of one set can be 90 degrees out of phase with the pulsed output of the display pixels of the other set.

The array of display pixels can also be arranged in first and second groups of display pixels, with the pulsed output of the display pixels of one group at a different frequency to the pulsed output of the display pixels of the other group.

This provides another way to avoid optical cross talk between pixels.

The invention also provides a method of driving pixels of an active matrix display device comprising an array of the pixels, the method comprising:

driving a current through a current-driven light emitting display element of the pixel as a series of pulses;

detecting the brightness of the display element using a light-dependent device arrangement which is controlled cyclically and which provides an output charge flow in dependence on the brightness of the display element; and

controlling the driving of the current through the display element in response to the light-dependent device arrangement output,

wherein for constant illumination of the light-dependent device arrangement during a cycle, there is a substantially zero net output charge flow.

Examples of the invention will now be described in detail with reference to the accompanying drawings, in which:

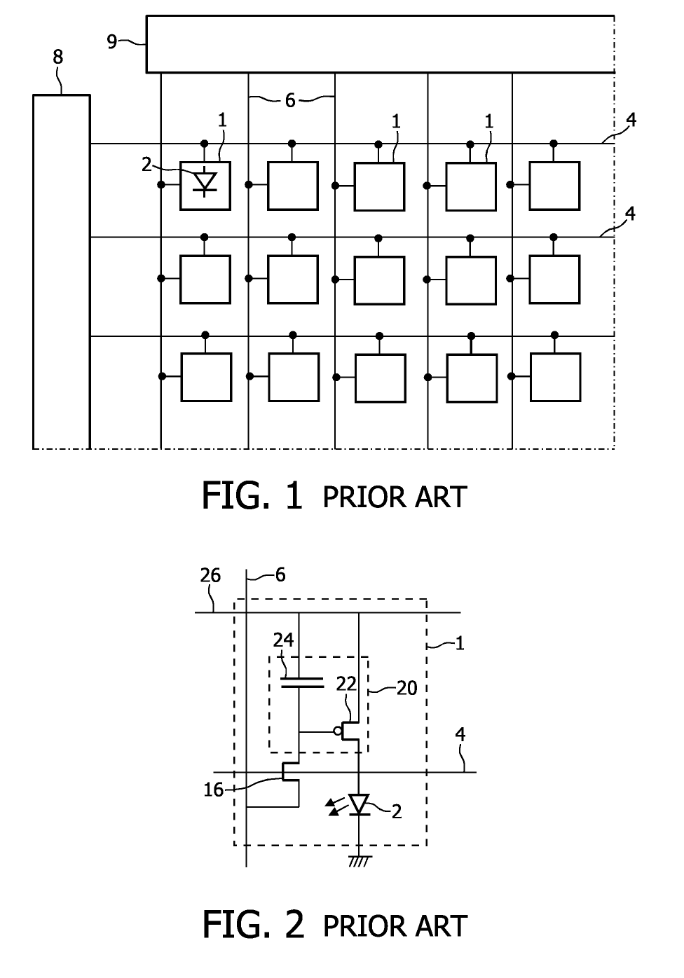

FIG. 1 is a simplified schematic diagram of an embodiment of active matrix EL display device;

FIG. 2 illustrates a known form of pixel circuit;

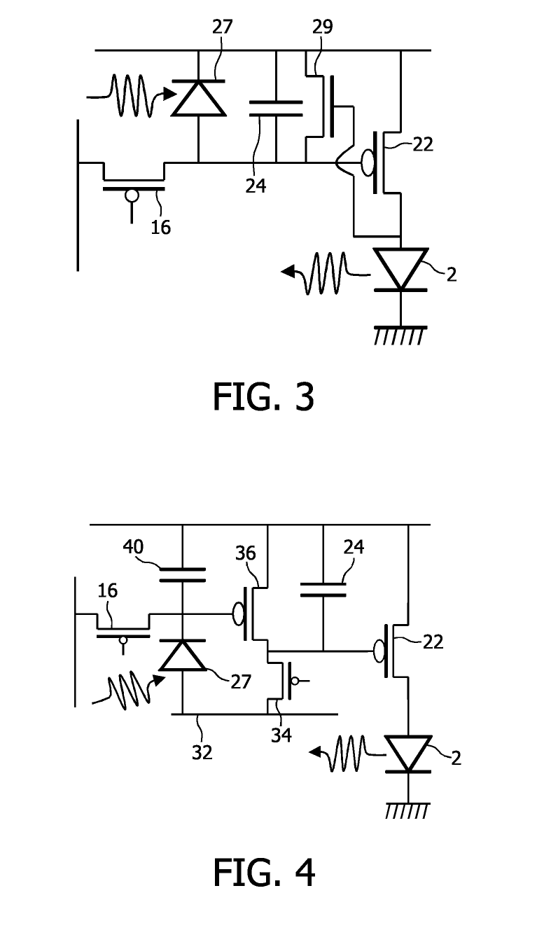

FIG. 3 shows a first known optical feedback pixel design;

FIG. 4 shows a second known optical feedback pixel design;

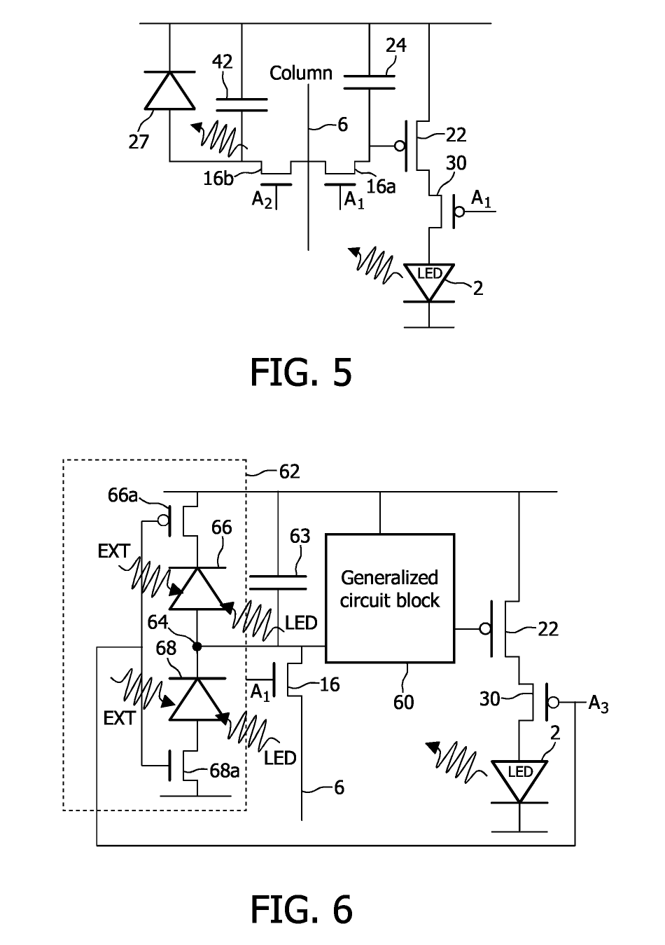

FIG. 5 shows a third known optical feedback pixel design;

FIG. 6 shows schematically pixels of a first version of display device to of the invention;

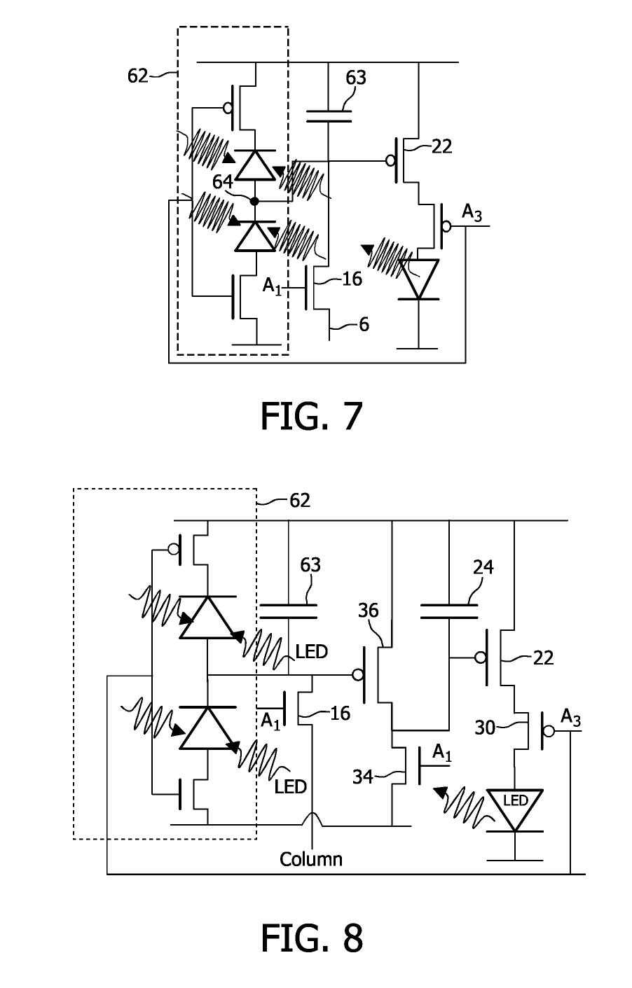

FIG. 7 shows a first more detailed example of pixel configuration of the invention of FIG. 6;

FIG. 8 shows a second more detailed example of pixel configuration of the invention of FIG. 6;

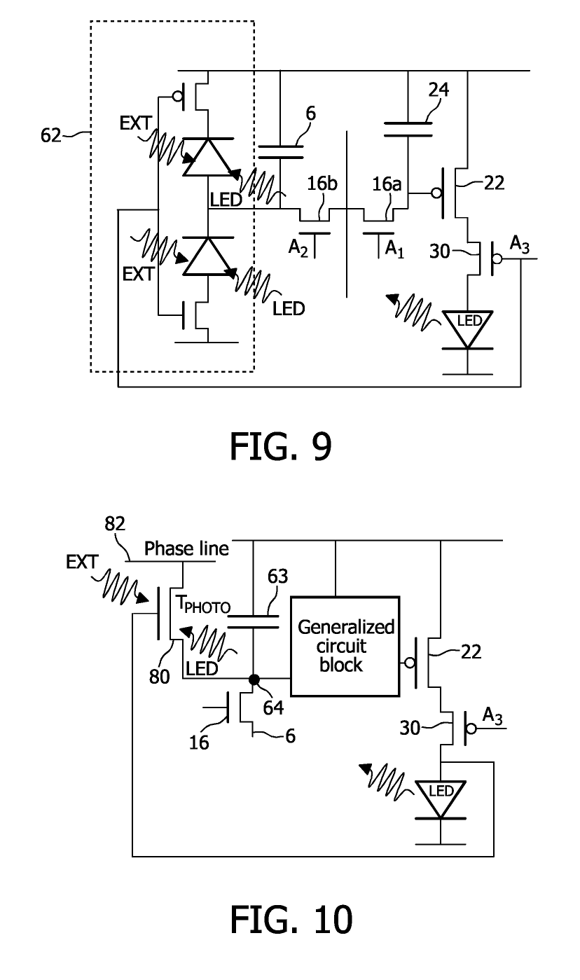

FIG. 9 shows a third more detailed example of pixel configuration of the invention of FIG. 6;

FIG. 10 shows schematically pixels of a second version of display device of the invention; and

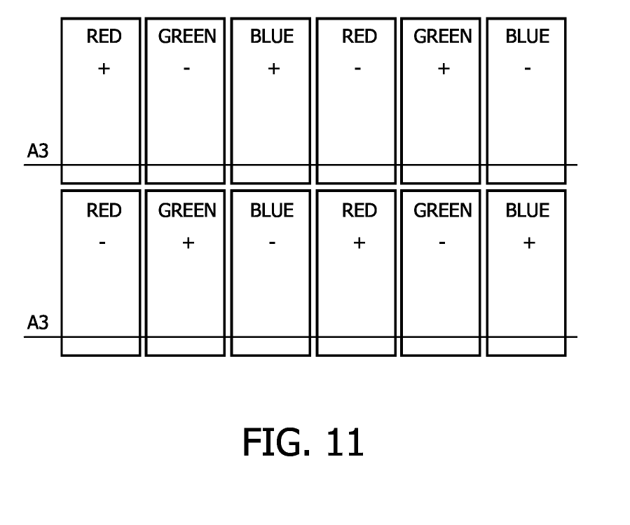

FIG. 11 shows a way of implementing cross talk insensitivity.

The same reference numbers are used throughout the Figures to denote the same or similar parts.

FIG. 1 shows a known active matrix electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of to transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support.

FIG. 2 shows in simplified schematic form the most basic pixel and drive circuitry arrangement for providing voltage-addressed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended.

The drive transistor 22 in this circuit is implemented as a p-type TFT, so that the storage capacitor 24 holds the gate-source voltage fixed. This results in a fixed source-drain current through the transistor, which therefore provides the desired current source operation of the pixel.

In the above basic pixel circuit, for circuits based on polysilicon, there are variations in the threshold voltage of the transistors due to the statistical distribution of the polysilicon grains in the channel of the transistors. Polysilicon transistors are, however, fairly stable under current and voltage stress, so that the threshold voltages remain substantially constant.

The variation in threshold voltage is small in amorphous silicon transistors, at least over short ranges over the substrate, but the threshold voltage is very sensitive to voltage stress. Application of the high voltages above threshold needed for the drive transistor causes large changes in threshold voltage, which changes are dependent on the information content of the displayed image. There will therefore be a large difference in the threshold voltage of an amorphous silicon transistor that is always on compared with one to that is not. This differential ageing is a serious problem in LED displays driven with amorphous silicon transistors.

In addition to variations in transistor characteristics there is also differential ageing in the LED itself. This is due to a reduction in the efficiency of the light emitting material after current stressing. In most cases, the more current and charge passed through an LED, the lower the efficiency.

FIGS. 3 to 5 show examples of pixel layout with optical feedback to provide ageing compensation.

In the pixel circuit of FIG. 3, a photodiode 27 discharges the gate voltage stored on the capacitor 24, causing the brightness to reduce. The display element 2 will no longer emit when the gate voltage on the drive transistor 22 (T_{drive}) reaches the threshold voltage, and the storage capacitor 24 will then stop discharging. The rate at which charge is leaked from the photodiode 27 is a function of the display element output, so that the photodiode 27 functions as a light-sensitive feedback device. Once the drive transistor 22 has switched off, the display element anode voltage reduces causing the discharge transistor 29 to turn on, so that the remaining charge on the storage capacitor 24 is rapidly lost and the luminance is switched off. This discharge transistor is in fact optional, and is for ensuring reset of the pixel before the next addressing phase, but this may not be required.

As the capacitor holding the gate-source voltage is discharged, the drive current for the display element drops gradually. Thus, the brightness tails off. This gives rise to a lower average light intensity.

FIG. 4 shows a circuit which has been proposed by the applicant, and which has a constant light output and then switches off at a time dependent on the light output.

The gate-source voltage for the drive transistor 22 is again held on a storage capacitor 24. However, in this circuit, this capacitor 24 is charged to a fixed voltage from a charging line 32, by means of a charging transistor 34. Thus, the drive transistor 22 is driven to a constant level which is independent of the data input to the pixel when the display element is to be illuminated. The brightness is controlled by varying the duty cycle, in particular by varying to the time when the drive transistor is turned off.

The drive transistor 22 is turned off by means of a discharge transistor 36 which discharges the storage capacitor 24. When the discharge transistor 36 is turned on, the capacitor 24 is rapidly discharged and the drive transistor turned off.

The discharge transistor 36 is turned on when the gate voltage reaches a sufficient voltage. A photodiode 27 is illuminated by the display element 2 and again generates a photocurrent in dependence on the light output of the display element 2. This photocurrent charges a discharge capacitor 40, and at a certain point in time, the voltage across the capacitor 40 will reach the threshold voltage of the discharge transistor 36 and thereby switch it on. This time will depend on the charge originally stored on the capacitor 40 and on the photocurrent, which in turn depends on the light output of the display element. The discharge capacitor initially stores a data voltage, so that both the initial data and the optical feedback influence the duty cycle of the circuit.

FIG. 5 shows an arrangement in which the optical feedback part of the pixel (the photodiode 27 and an associated capacitor 42) provide information to external circuitry using the column data line 6. The optical feedback information is monitored, and this information is used to alter the data applied to the pixel to provide the different compensation effects. The optical feedback information is obtained with the pixel isolated from the data column by the address transistor 16a, and this arrangement has a second address transistor 16b to enable data to be provided to the column during the feedback phase. The pixel circuit also has an isolating transistor 30 which can be used to prevent any optical output from the display element during resetting and while data is being loaded into the pixel. The isolating transistor 30 of FIG. 5 can also be used in the circuit of FIG. 4. There are many alternative implementations of pixel circuit with optical feedback. FIGS. 3 to 5 show p-type implementations, and there are also n-type implementations, for example for amorphous silicon transistors.

The invention will now be described generally with reference to FIG. 6.

The circuit of FIG. 6 shows a generalized circuit to enable the effects of external luminance to be removed.

The pixel circuit comprises the current-driven light emitting display element 2, drive transistor 22 and isolating transistor 30. To control the voltage applied to the drive transistor gate, a generalized circuit block 60 is shown, which receives a charge flow from a light-dependent device arrangement 62, which detects the brightness of the display element. A capacitor 63 is associated with the light-dependent device arrangement.

In this circuit, the isolating transistor 30 is used for providing a pulsed light output from the display element. The light-dependent device arrangement 62 is also controlled cyclically such that, for constant illumination of the light-dependent device arrangement during a cycle, there is a substantially zero net output charge flow.

To achieve this, the arrangement 62 can provide charge flow to/from an output node 64 in both directions. In the example of FIG. 6, the light-dependent device arrangement 62 comprises first and second photodiodes 66, 68 in series with the same polarity between power lines. The output node 64 is at the junction between the photodiodes. Both photodiodes are reverse biased by the power lines to which they are connected, but a charge flow path is only provided to one of the power lines at a time, so that minority carrier currents can only flow through one of the photodiodes at a time. As shown, each photodiode is connected to its power line through a respective transistor 66a,68a, and these are switched in complementary manner. One way to achieve this is to provide opposite type transistors and have a common control signal.

The common control signal actuates the photodiodes alternately in cyclic manner. If there is constant illumination of the two photodiodes, the net charge flow to the capacitor 63, averaged over the period of the cycle, will be zero.

However, the display element output is pulsed, so that the display element output is always timed with the actuation of only one of the photodiodes. There will therefore be a net charge flow to or from the capacitor 63 resulting from the display output, and a feedback scheme can be implemented.

This arrangement uses a pulsed light output, and arranges the optical feedback to operate only in response to a corresponding pulsed light input. In this way, ambient light, which will be uniform over the time period of the cycle of operation, will not influence the optical feedback system. In this way, the system is not influenced by ambient light conditions.

In the example of FIG. 6, the transistors 66a, 68a are controlled by the same control signal used to control the isolation transistor 30, which provides the pulse timing control signal for the display element. This links the dependence of the optical feedback on the characteristics of the light output.

This shared control line is operated with a square wave of a particular frequency.

The generalized circuit block 60 can be implemented in many different ways, for example to implement the circuits of FIGS. 2 to 5. In the simplest implementation, shown in FIG. 7, the block 60 is simply a connection between the node 64 and the gate of the drive transistor. This most basic circuit implementation corresponds to the circuit of FIG. 3, without the use of the discharge transistor 29.

FIG. 8 shows how the circuit block 60 is implemented to provide circuit operation corresponding to that explained with reference to FIG. 4.

The circuits shown in 7 and 8 will modulate the light output, as the isolating transistor 30 has a square wave control signal applied. If this is at sufficiently high frequency, this will not be seen by the eye. However, the more basic circuit in FIG. 7 has a very rapid luminance decay so may not work as well as the snap-off circuit of FIG. 8.

FIG. 9 shows an implementation of the invention based on the external monitoring technique explained with reference to FIG. 5. The circuit of FIG. 9 can be arranged so that it does not modulate the light output, by performing the measurement phase at times when the display is not in normal use, for example at switch on or switch off of the display. This measurement phase does not need to be performed with high frequency, as it is for to compensating longer term ageing effects of the display element and the drive transistor.

The circuits above all use double-photodiode circuits to provide the cancellation of charge flow. This concept can instead be implemented by a single photosensitive thin film transistor (TFT).

FIG. 10 shows a generalized circuit for the use of a photosensitive transistor, which can be controlled to provide photocurrent in opposite directions in dependence on the operation cycle.

The phototransistor 80 again provides current to or drains current from the node 64 to charge or discharge the capacitor 63. Depending on the bias of the source and drain terminals, the transistor can conduct in either direction, and the photosensitive leakage currents can thus be made to flow in either direction. This requires control of the source-drain voltage as well as the gate voltage. To achieve this, the transistor is connected between the node 64 and a phase line 82.

The TFT is arranged so that, in one phase, it will source current to the node 64, and in the other phase will sink current from it. The light from the display element is incident on the TFT during an illumination phase, and external light is also incident on the photo TFT all the time. The phase line 82 controls the bias of the TFT, which is held OFF at all times by an appropriate gate control signal.

If the phase line voltage is above the node voltage then the TFT will source current into the node. In the other phase, the phase line voltage is below the node voltage and so the TFT sinks current from the node. The TFT must be held OFF in both phases for this to work. This can be achieved by holding the gate voltage very low. However, this changes the biasing condition from phase to phase and may adversely effect the operation of the pixel.

The ideal condition is to control the gate voltage directly to maintain the same gate-source voltage for each phase.

FIG. 10 shows one way to approach this ideal condition, in which the gate voltage is connected to the anode of the display element 2. As an example, the power voltage may be 10V, and the node voltage may be to arranged to be approximately 5V (although this voltage will fluctuate during pixel operation). The phase line can then move between 10V and 0V to ensure the TFT sources and sinks current correctly. The gate voltage would then ideally move from 5V to 0V to provide the same gate-source conditions on the TFT, namely with the gate voltage equal to the source voltage for maintaining the n-type TFT just off. The anode will be at approximately 5V when the LED is on and 0V when it is off. The anode of the display element can therefore approximately give this correct biasing.

The circuits described above will only cancel out external light that is constant over the period of oscillation, and this will be sufficient for nearly all forms of external light as the square wave period on the pulse/cyclic control line will be of order of a line time (for example tens microseconds). However, display elements in other pixels will be creating modulated light exactly at the same frequency, and this will not be cancelled if such light can reach other pixels.

Blocking light between pixels can be achieved using the physical structure of the pixel design. However, this can be avoided by modifying the feedback scheme as explained below.

Neighbouring pixels in particular may leak light into the light sensitive device in the pixel of interest. One solution is to arrange the pixels so that all neighbours modulate their light output using different phases.

In particular, if one pixel operates 90 degrees out of phase with a neighbouring pixel, then the output of that one pixel will be timed such that the half the illumination time corresponds to one actuated photodiode of the neighbouring pixel and the other half of the illumination time corresponds to the other actuated photodiode.

To implement this approach, different groups of pixels simply need out of phase pulsing and feedback control (control line A3). Thus, two sets of pixels are defined, with different timing of the light pulsing and feedback control.

To provide effective shielding between adjacent pixels, the two sets of pixels can have a checkerboard pattern, as shown in FIG. 11, with one set of to pixels denoted by a + sign and the other set of pixels denoted by a − sign. FIG. 11 also shows pixels formed as a linear array of three RGB sub-pixels, and the phase pattern is applied on the individual sub-pixel level.

This enables the pulsed output of each pixel to be out of phase with the pulsed output of the pixel on each side and above and below in the array. The pulsed output of the display pixels of one set can be 90 degrees out of phase with the pulsed output of the display pixels of the other set.

This cross talk elimination can be enhanced by changing the frequency of oscillation on different groups of pixels, for example different rows. If on row n, the pulse/cyclic control line oscillates at frequency f, then on lines n−1 and n+1 the pulse/cyclic control line can oscillate at frequency 2f or f/2.

The drive scheme of the invention involves driving a current through a current-driven light emitting display element of the pixel as a series of pulses and detecting the brightness of the display element using a light-dependent device arrangement which is controlled cyclically and which provides an output charge flow in dependence on the brightness of the display element. The driving of current through the display element is controlled in response to the light-dependent device arrangement output, and this output is insensitive to ambient or other substantially time-constant illumination.

As will be apparent from the above, photodiode light sensors can be used, or amorphous silicon photo TFTs. In these TFTs photons absorbed in the channel between source and drain generate a photocurrent which can be sensed by the source and drain electrodes. The photocurrent can also be influenced by the gate electrode on top of the amorphous silicon layer, and thus balanced operation. A low temperature polysilicon photo TFT can also be used as the photosensitive device.

Display devices of the invention will find particular application as flat panel displays in mobile applications (Phone, PDA, digital camera), in (laptop) monitors, and in televisions.

The processes involved in the manufacture of the display devices of the invention have not been described in this application, as they will be conventional and routine to those skilled in the art. Amorphous silicon, to polysilicon, microcrystalline silicon or other semiconductor transistor technologies may be employed. The invention can be applied to any pixel circuit in which a photosensitive device is used as a feedback element for each pixel.

From reading the present disclosure, other modifications will be apparent to persons skilled in the art. Such modifications may involve other features which are already known in the field of active matrix EL display devices and component parts therefor and which may be used instead of or in addition to features already described herein.

1. An active matrix display device comprising an array of display pixels, each pixel comprising:
a current-driven light emitting display element;
a light-dependent device arrangement for detecting the brightness of the display element and providing an output charge flow in dependence on the brightness of the display element; and
a drive transistor for driving a current through the display element, wherein the drive transistor is controlled in response to the light-dependent device arrangement output, wherein
the current-driven light emitting display element is controlled to provide a pulsed output, and
the light-dependent device arrangement is controlled cyclically such that, for constant illumination of the light-dependent device arrangement during a cycle, there is a substantially zero net output charge flow.

2. A device as claimed in claim 1, wherein the light dependent device arrangement is controlled by a control signal having the same timing as a pulse timing control signal for the display element.

3. A device as claimed in claim 2, wherein a shared control signal provides the pulse timing control and cyclic control.

4. A device as claimed in claim 1, wherein the light-dependent device arrangement comprises first and second photodiodes in series between power lines, with the output from the arrangement at the junction between the photodiodes, and wherein the cyclic control actuates the photodiodes alternately.

5. A device as claimed in claim 4, wherein the light-dependent device arrangement further comprises first and second transistors each in series with a respective photodiode for providing the actuation of the photodiodes.

6. A device as claimed in claim 1, wherein the drive transistor, the display element and a pulsing transistor are in series between power lines, the pulsing transistor being switched a pulse timing control signal.

7. A device as claimed in claim 1, wherein the light-dependent device arrangement comprises a phototransistor, which is controlled to provide photocurrent in opposite directions in dependence on the operation cycle.

8. A device as claimed in claim 7, wherein the phototransistor is connected between a phototransistor control line and the output of the arrangement, and the gate of the phototransistor is provided with a cyclic control signal.

9. A device as claimed in claim 7, wherein the drive transistor, the display element and a pulsing transistor are in series between power lines, the pulsing transistor being switched by a pulse timing control signal.

10. A device as claimed in claim 9, wherein the cyclic control signal comprises the voltage on one of the terminals of the display element.

11. A device as claimed in claim 1, wherein the array of display pixels comprises at least first and second sets of display pixels, and wherein the pulsed output of the display pixels of one set is out of phase with the pulsed output of the display pixels of the other set.

12. A device as claimed in claim 11, wherein the pulsed output of each pixel is out of phase with the pulse output of the pixel on each side.

13. A device as claimed in claim 11, wherein the pulsed output of each pixel is out of phase with the pulse output of the pixel above and below in the array.

14. A device as claimed in claim 11, wherein the pulsed output of the display pixels of one set is 90 degrees out of phase with the pulsed output of the display pixels of the other set.

15. A device as claimed in claim 1, wherein the array of display pixels comprises at least first and second groups of display pixels, and wherein the pulsed output of the display pixels of one group is at a different frequency to the pulsed output of the display pixels of the other group.

16. A device as claimed in claim 15, wherein the pulsed output of each pixel of one group is at twice the frequency of the pulsed output of each pixel of the other group.

17. A device as claimed in claim 1, wherein the light emitting display element comprises an electroluminescent display element.

18. A method of driving pixels of an active matrix display device comprising an array of the pixels, the method comprising:
driving a current through a current-driven light emitting display element of the pixel as a series of pulses;
detecting the brightness of the display element using a light-dependent device arrangement which is controlled cyclically and which provides an output charge flow in dependence on the brightness of the display element; and
controlling the driving of the current through the display element in response to the light-dependent device arrangement output,
wherein for constant illumination of the light-dependent device arrangement during a cycle, there is a substantially zero net output charge flow.

19. A method as claimed in claim 18, further comprising controlling the light dependent device using a control signal having the same timing as a pulse timing control signal for the display element.

20. A method as claimed in claim 18, wherein controlling cyclically the light-dependent device arrangement comprises actuating first and second photodiodes in series between power lines alternately, with the output from the arrangement at the junction between the photodiodes.

21. A method as claimed in claim 20, wherein actuating the photodiodes alternately comprises switching first and second transistors alternately, each in series with a respective photodiode for providing the actuation of the photodiodes.

22. A method as claimed in claim 18, wherein controlling cyclically the light-dependent device arrangement comprises controlling a phototransistor to provide photocurrent in opposite directions in dependence on the operation cycle.

23. A method as claimed in claim 18, wherein driving a current through a current-driven light emitting display element of the pixel as a series of pulses comprises switching a pulsing transistor with a pulse timing control signal, the drive transistor, the display element and the pulsing transistor in series between power lines.

24. A method as claimed in claim 18, further comprising providing a pulsed output of the display pixels of one set of pixels out of phase with the pulsed output of the display pixels of another set of display pixels.

25. A method as claimed in claim 18, further comprising providing a pulsed output of the display pixels of one group of pixels at a different frequency to the pulsed output of the display pixels of another group of display pixels.
